(19) United States
(12) Patent Application Publication
(10) Pub. No.: US 2022/0234133 A1
(43) Pub. Date: Jul. 28, 2022

(54) FIXING A STRIP END SEGMENT OF A METAL STRIP COIL TO AN ADJACENT STRIP WINDING

(71) Applicant: SMS group GmbH, Düsseldorf (DE)

(72) Inventors: Andreas KREX, Siegen (DE); Guido FICK, Kreuztal (DE); Sebastian BÖCKING, Siegen (DE)

(73) Assignee: SMS group GmbH, Düsseldorf (DE)

(21) Appl. No.: 17/618,141

(22) PCT Filed: Mar. 30, 2020
(86) PCT No.: PCT/EP2020/058955

§ 371 Date: Dec. 10, 2021

(30) Foreign Application Priority Data
Jun. 13, 2019 (DE) 10 2019 208 607.1
Jan. 16, 2020 (DE) 10 2020 200 472.2

(51) Int. Cl. B23K 20/12

(52) U.S. Cl. CPC B23K 20/1225; B23K 2101/16; B23K 20/1245; B23K 20/1265

(57) ABSTRACT

A method for fixing a strip end segment of a metal strip wound into a coil to a strip winding of the coil arranged adjacent to the strip end segment. In order to enable the production of metal strip with improved quality, the strip end segment is fixed by materially bonding on the strip winding by means of a friction welding method.

The invention relates to a method for fixing a strip end segment of a metal strip wound into a coil to a strip winding of the coil arranged adjacent to the strip end segment. Furthermore, the invention relates to a device for fixing a strip end segment of a metal strip wound into a coil to a strip winding of the coil arranged adjacent to the strip end segment.

One end product of a rolling train is a metal strip coil, hereinafter simply referred to as a coil, which is produced by winding a rolled metal strip onto a reel mandrel of a winding device. After the winding process, the coil is drawn off of the reel mandrel. In further process steps, it is pushed back onto a reel mandrel of another winding device and then unwound.

The strip end segment, which is arranged in an inner coil eye located on the radial inside, of the metal strip wound to form the coil having the inner coil eye tends to collapse. This strip end segment therefore has to be fixed so that the coil can be pushed securely onto the reel mandrel of another winding device during subsequent processing operations.

Manually welding the strip end segment lying in the inner coil eye to a strip winding of the coil arranged adjacent to the strip end segment in order to fix the strip end segment is known. However, this manual welding is associated with poor occupational safety and personal safety, since the welding work is carried out on a coil which usually has a temperature of approximately 400° C. In addition, the welding is very time-consuming, which is accompanied by high personnel costs. Furthermore, manual welding is usually associated with a high consumption of consumables, such as a welding wire, a welding gas, a protective gas, or the like.

Fixing the strip end segment lying on the coil outer circumference on the rest of the coil by means of a coil binding strip machine is also known. This is also accompanied by a high consumption of consumables in the form of binding strips. This fixation is required because the outer turn(s) tend to spring open due to the internal tension and thus make further handling of the coil more difficult.

A method for producing a coil from metallic strip is known from EP 2 982 452 A1, in which the strip is wound onto an expandable reel mandrel and the fully wound coil is placed on a coil carriage and transported away from the reel mandrel. The method comprises winding the strip onto the expanded reel mandrel, picking up the fully wound coil on the coil carriage, expanding the reel mandrel and moving the coil out of the reel mandrel by a relative movement between the reel mandrel and the coil carriage in the direction of the axis of the reel mandrel, wherein one such movement takes place so that the axial end of the reel mandrel is moved away from the end face of the coil located in the coil eye by a predetermined amount, wherein the predetermined amount is less than the width of the coil.

The method further comprises expanding the reel mandrel, setting a fixation between at least two superimposed strip parts of the strip in the area of the coil eye from which the reel mandrel was removed, and collapsing the reel mandrel and completely moving the coil out of the reel mandrel by way of a relative movement between the reel mandrel and the coil carriage in the direction of the axis of the reel mandrel. The setting of the fixation can create a connection between at least two superimposed strip parts by way of a material bond, in particular by way of electrical or autogenous spot welding.

JP H02 235 580 A and JP H05 269 526 A each disclose a method for fixing a strip end segment, located in an inner coil eye, of a metal strip wound into a coil having the coil eye to a strip winding of the coil arranged adjacent to the strip end segment using a thermal welding method.

One object of the invention is to enable the strip end segments to be secured on the coil more easily and with improved process reliability, without simultaneous losses of quality.

This object is achieved by the independent claims. Advantageous embodiments are given in the following description, the dependent claims, and the figures, wherein these embodiments taken individually or in combination of at least two of these embodiments with one another can represent a refining, in particular also preferred or advantageous, aspect of the invention. Embodiments of the method can correspond to embodiments of the device, and vice versa, even if this is not explicitly noted in the following in the individual case.

According to the method according to the invention for fixing a strip end segment of a metal strip wound into a coil to a strip winding of the coil arranged adjacent to the strip end segment, the strip end segment is fixed by material bonding on the strip winding by a friction welding method. The friction welding method used can be a friction stir welding method or, preferably, a friction spot welding method.

According to the invention, the strip end segment of the metal strip wound to form the coil having the coil eye is fixed by material bonding or welded to the strip winding of the coil arranged adjacent to the strip end segment without a conventional external input of thermal energy. This prevents fusion welding methods from occurring and thus a change in material properties of the metal strip as a result of the welding, so that overall a metal strip of higher quality can be provided. In addition, the invention reliably avoids markings, for example on rolls, in subsequent process steps that would arise during the machining of the metal strip due to hardened material strips of the strip end segment or the strip winding arranged adjacent to it, which would be produced by a thermal welding method with or without filler material. Also, the invention does not contaminate the resulting scrap with welding fillers. The joining method according to the invention manages without the use of a welding filler material, which could damage the rolls of a cold rolling mill in a further process. In addition, the method according to the invention enables a targeted connection of only two strip layers. Furthermore, in the method according to the invention, there is no current passage due to grounding currents through the wound metal strip.

The strip end segment can be arranged in the inner coil eye, which is formed as an axial passage opening of the coil arranged radially on the inside and coaxially or can be arranged radially on the outside of the coil at the outer diameter. Both strip end segments of the metal strip, which are given in the strip longitudinal direction, can also be fixed by means of the method according to the invention.

For reasons of simplicity, the invention is described below with a view to fixing the inner strip end segment, since this represents the complex object. The transfer of the mode of action to the outer strip end segment is included without restriction.

By means of the preferred friction spot welding method, a single spot weld can be formed or at least two spot welds are formed which, for example, can be arranged in a row with respect to one another with respect to a strip width of the metal strip. It is also possible to produce two or more such rows of spot welds, which can be aligned parallel to one another.

By means of the friction stir welding method used, a single short weld seam can be formed or at least two weld seams are formed, which can be arranged in a row one behind the other with respect to the strip width of the metal strip, for example.

The method according to the invention is particularly suitable for coils made of rolled aluminum strip, but can also be used for metal strips formed in other ways, in particular thin strips, having a strip thickness of up to approximately 12 mm. The metal strip can be a hot strip or a cold strip. Alternatively, to an aluminum strip, the metal strip can be, for example, a steel strip, a copper strip, or a metal strip made from another non-ferrous metal. The aluminum strip can be a hot strip having a temperature of up to 400° C., for example. Process parameters of the method according to the invention can be set in such a way that only the strip end segment is welded to the strip winding arranged adjacent to it, that is to say without this strip winding being welded to a further strip winding arranged radially on the outside in relation thereto.

The method according to the invention is suitable for subsequent heat treatment steps on the coil, since strip materials having the same physical key data are connected to one another without foreign material or filler material. In this way, the invention ensures an unmixed material circulation.

To carry out the method according to the invention, the coil can first be completely drawn off of a reel mandrel of a winding device and placed on a shelf. The shelf can accommodate the coil statically or it can be designed in such a way that the position of the coil can be changed. To facilitate the movement of the coil together with the shelf, the shelf can be driven. A friction welding device can then be arranged in front of the coil and used to be able to carry out the friction welding. After the friction welding has been completed, the friction welding device can be removed again and the coil can be transported to its next processing location, for example by means of the shelf. The method according to the invention is thus carried out outside of the reel, so that there is no increase in non-productive times and work in safety-relevant facility parts is avoided.

According to one advantageous embodiment, the friction welding method is carried out by means of a welding robot. The welding is thus automated, which saves personnel costs, increases facility and personal safety due to the elimination of manual welding work on hot coils and, due to the higher accuracy of the automation, is associated with a reduction in consumables. The welding robot can have at least one friction welding device and at least one driven robot arm holding the friction welding device. The welding robot can provide a rotating function for the friction welding device to be able to move the friction welding device into the inner coil eye of the coil with reduced force, or to be able to apply it to the coil outer diameter. To control the welding robot, a database model can be used, for example, which provides process parameters to be able to take into consideration parameters, for example, the material alloy, the material temperature, the material dimensions, or the like.

According to a further advantageous embodiment, at least the strip end segment is automatically pressed radially against the adjacent strip winding while the friction welding method is being carried out. As a result, loose strip windings of the coil can be brought into contact with one another in pairs, which improves the winding quality of the coil and at the same time creates better contact between the strip end segment and the strip winding arranged adjacent to it. The latter creates greater security for the method according to the invention with respect to the production of a high-quality friction-welded connection. To be able to automatically press the strip end segment radially outward against the adjacent strip winding, a conical mandrel, which is for example expandable, can be inserted into the inner coil eye. To be able to automatically press the strip end segment radially inward against the adjacent strip winding, a flattened contact pressure surface can be pressed against the outer coil diameter, for example.

According to a further advantageous embodiment, a position and/or a shape of the strip end segment is automatically detected before the friction welding method is carried out. The detected position of the strip end segment relative to the friction welding device of the welding robot and/or the shape of the strip end segment can be taken into consideration during operation of the welding robot in order to be able to place at least one welding point/seam at an optimal position of the strip end segment.

According to a further advantageous embodiment, before the friction welding method is carried out, a space available within an inner coil eye of the coil for a friction welding device of the welding robot insertable therein is automatically detected. This check can also be referred to as a plausibility check and is carried out before the start of the welding method. This prevents the friction welding device from colliding with the coil if there is insufficient space for the friction welding device in the coil eye. This avoids damage to the coil and to the friction welding device. The information as to whether a space available within the coil eye for a friction welding device of the welding robot to be inserted therein is sufficient for inserting the friction welding device or not can be taken into consideration when operating the welding robot.

According to a further advantageous embodiment, the friction welding device is automatically supported on the coil while the friction welding method is being carried out. As a result, a robot arm of the welding robot holding the friction welding device can be relieved while the friction welding method is being carried out. In addition, a sufficient friction welding force can be ensured by the support. The friction welding device can, for example, be supported radially on the outside of the coil or within the inner coil eye of the coil.

A device according to the invention for fixing a strip end segment of a metal strip wound into a coil to a strip winding of the coil arranged adjacent to the strip end segment has at least one holding device for connecting the strip end segment to the strip winding by material bonding, wherein the holding device has at least one friction welding device. The friction welding device is a friction spot welding device, or a friction stir welding device. In one preferred embodiment, the holding device is designed as a welding robot.

The advantages mentioned above in reference to the claimed method are linked accordingly to the device. In particular, the method can be carried out in accordance with one of the above-mentioned embodiments or a combination of at least two of these embodiments with one another using the device according to the invention. The device can have at least one control electronics unit for controlling the welding robot/the holding device. Furthermore, the device can have at least one sensor system connected to the control electronics unit, wherein the control electronics unit can be configured to control the welding robot/the holding device taking into consideration measured values of the sensor system.

According to a further advantageous embodiment, the welding robot/holding device has at least one sensor unit for detecting a position and/or a shape of the strip end segment and/or for detecting a space available within an inner coil eye of the coil for the friction welding device insertable therein. The embodiments mentioned above with reference to the corresponding embodiments of the method are correspondingly linked with these embodiments. The sensor unit can be, for example, an optical sensor unit.

According to a further advantageous embodiment, the welding robot/the holding device has at least one protective unit for external protection of the friction welding device and/or at least one cooling unit for cooling the friction welding device. The protective unit can protect the friction welding device from mechanical influences and for this purpose can partially surround the friction welding device. The cooling unit can be an active cooling unit having a cooling circuit.

According to a further advantageous embodiment, the welding robot/the holding device has at least one support unit for automatically supporting the friction welding device on the coil. The advantage mentioned above with reference to the corresponding embodiment of the method is correspondingly linked to this embodiment.

In the following, the invention is explained by way of example with reference to the attached figures using preferred embodiments, wherein the features explained below can represent an advantageous or refining aspect of the invention both individually and in combination of at least two of these features with one another. In the figures:

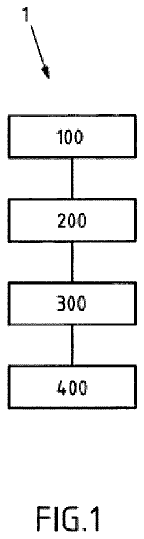

FIG. 1: shows a flow chart of an exemplary embodiment for a method according to the invention.

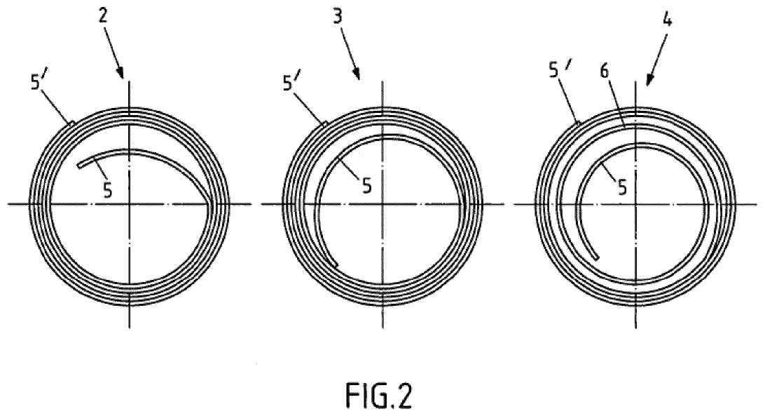

FIG. 2: shows a schematic side view of three different coils having non-fixed inner strip end segment or outer strip end segment.

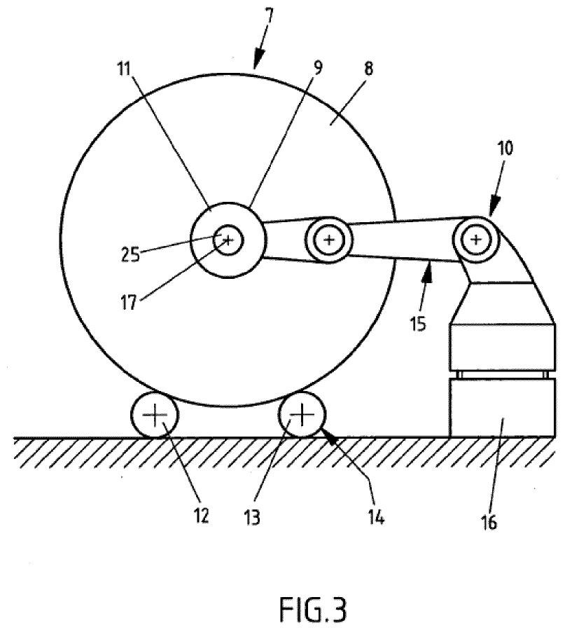

FIG. 3: shows a side view of an exemplary embodiment of a device according to the invention,

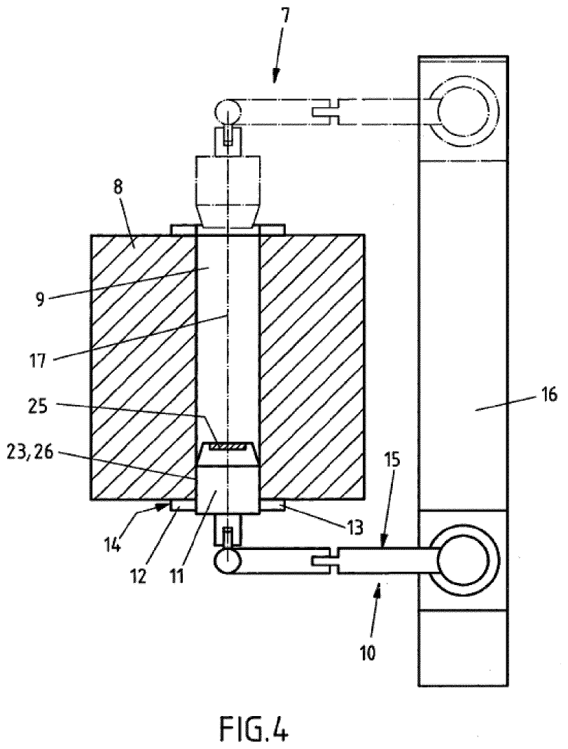

FIG. 4: shows a schematic top view of the device shown in FIG. 3; and

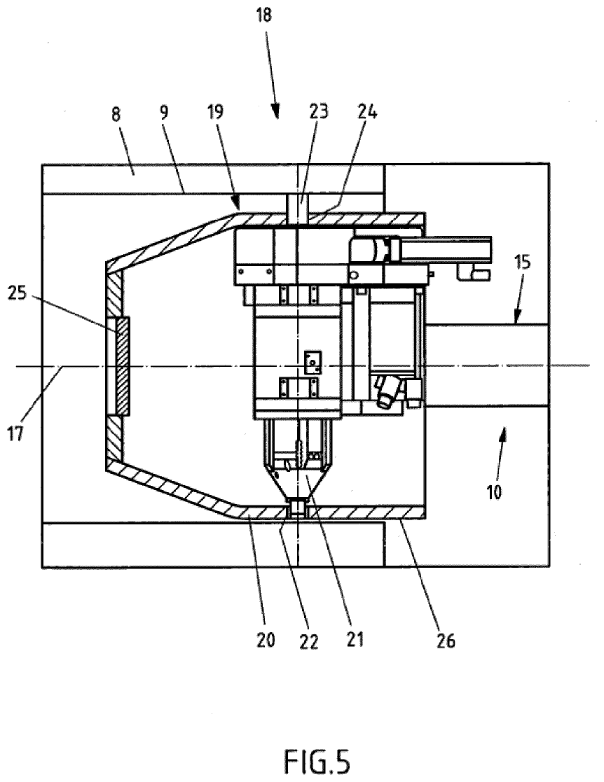

FIG. 5: shows a schematic sectional illustration of a further exemplary embodiment of a device according to the invention.

In the figures, identical or functionally identical elements are provided with the same reference signs. A repeated description of these components can be omitted.

FIG. 1 shows a flow chart of an exemplary embodiment of a method 1 according to the invention for fixing a strip end segment (not shown), located in an inner coil eye (not shown), of a metal strip (not shown) that is wound into a coil (not shown) having the coil eye to a strip winding (not shown) of the coil arranged adjacent to the strip end segment. A device according to the invention (not shown), can be used to carry out the method 1.

In method step 100, the coil is drawn off of a reel mandrel (not shown) and deposited on a roller table (not shown) for which purpose a crane, a coil lift truck, or the like can be used, for example. In addition, in method step 100, the coil can be transported by means of a coil lift truck or the like to a location at which the strip end segment is to be fixed by carrying out a friction welding method by means of a welding robot or at which the strip end segment is to be fixed by material bonding to the strip winding by the friction welding method.

In method step 200, a position and/or a shape of the strip end segment is automatically detected by means of at least one sensor unit (not shown). Furthermore, in method step 200 it is detected whether a space available within the coil eye for a friction welding device (not shown) of the welding robot insertable therein is sufficient for this insertion or not.

If the space detected in method step 200 is sufficient for inserting the friction welding device into the coil eye, the friction welding device is inserted into the coil eye in method step 300.

The friction welding method is then carried out in method step 400. In method step 400, at least the strip end segment can be automatically pressed radially outward against the adjacent strip winding while the friction welding method is being carried out. In addition, in method step 400, the friction welding device can be automatically supported within the coil eye while the friction welding method is being carried out. In method section 400, the friction welding device is alternatively or additionally supported from the outside against the coil surface in order to press the outer strip end segment against the coil surface and the adjacent strip winding.

FIG. 2 shows a schematic side view of three different coils 2, 3, and 4 having a non-fixed inner strip end segment 5. This allows the inner strip end segment 5 to collapse or bend locally, as shown on the left in FIG. 2. Furthermore, the inner strip end segment 5 can collapse or curve inward as a whole, as is shown in the center of FIG. 2. An outer strip end segment 5 can also protrude from the outside of the coil, as shown on coil 3. In addition to the inner strip end segment 5, further strip windings 6 can collapse or bend, as is shown on the right in FIG. 2

FIG. 3 shows a schematic side view of an exemplary embodiment of a device 7 according to the invention for fixing an inner strip end segment (not shown) of a metal strip (not shown) wound into a coil 8 to a strip winding (not shown) of the coil 8 arranged adjacent to the strip end segment. The coil 8 has an inner coil eye 9. The device 7 has a shelf 14 formed by two rollers 12 and 13, on which the coil 8 is placed.

The device 7 has a welding robot 10 for the materially-bonded connection of the strip end segment to the strip winding. For this purpose, the welding robot 10 has a friction welding device 11. Moreover, the welding robot 10 has a preferably multi-link robot arm 15 holding the friction welding device 11. In addition, the welding robot 10 has a stationary linear guide 16 on which the robot arm 15 is displaceably arranged in order to be displaceable parallel to a longitudinal axis 17 of the coil 8 perpendicular to the plane of the drawing of FIG. 3.

The welding robot 10 also has a sensor unit 25 for detecting a position and/or a shape of the strip end segment and/or for detecting a space available within the coil eye of the coil for the friction welding device 11 to be inserted therein. In addition, the welding robot 10 has a protective unit (not shown) for the external protection of the friction welding device 11 and/or at least one cooling unit (not shown) for cooling the friction welding device 11. The welding robot 10 furthermore has a support unit 26 for automatically supporting the friction welding device 11 on the coil 8.

FIG. 4 shows a schematic top view of the device 7 shown in FIG. 3. The device 7 is shown in two different positions. In the position shown by solid lines, the friction welding device 11 is inserted into one end of the coil eye 9, while in the position shown by dashed lines, it is positioned in front of the other end of the coil eye 9, to be able to fix the inner strip end segment (not shown in FIG. 4) of the coil 8 on both ends of the coil eye 9.

FIG. 5 shows a schematic sectional illustration of a further exemplary embodiment of a device 18 according to the invention for fixing an inner strip end segment (not shown) of a metal strip (not shown) wound to form a coil 8 to a strip winding (not shown) of the coil 8, which is arranged adjacent to the strip end segment. The device 18 can otherwise be designed in accordance with the exemplary embodiment shown in FIGS. 3 and 4.

The friction welding device 19 of the device 18 has a housing 20 which is conically tapered on an insertion side in order to facilitate the insertion of the friction welding device 19 into the coil eye 9 of the coil 8. The sensor unit 25 and the support unit 26 for automatic support on the coil external diameter are additionally located on this housing. The friction welding device 19 moreover has a friction welding unit 21 which can carry out a friction spot welding method or a friction stir welding method through an opening 22 in the housing 20. In addition, the friction welding device 21 has a support unit 23 for automatically supporting the friction welding device 19 on the coil 8, which can be brought into contact with the coil 8 through a further opening 24 in the housing 20.

### LIST OF REFERENCE SIGNS

1 method

2 coil

3 coil

4 coil

5 strip end segment

5′ strip end segment

6 strip winding

7 device

8 coil

9 coil eye

10 holding device/(welding) robot

11 friction welding device

12 roller

13 roller

14 shelf

15 robot arm

16 linear guide

17 longitudinal axis of 8

18 device

19 friction welding device

20 housing of 19

21 friction welding unit

22 opening on 20

23 support unit of 19

24 opening on 20

25 sensor unit

26 support unit of 19

100 method step

200 method step

300 method step

400 method step

1-14. (canceled)

15. A method for fixing a strip end segment of a metal strip wound to form a coil to a strip winding of the coil arranged adjacent to the strip end segment, wherein the strip end segment is fixed by material bonding on the strip winding by a friction welding method.

16. The method as claimed in claim 15, wherein the friction welding method is a friction spot welding method.

17. The method as claimed in claim 15, wherein the friction welding method is a friction stir welding method.

18. The method as claimed in claim 15, wherein the friction welding method is carried out by means of a welding robot.

19. The method as claimed in claim 15, wherein while the friction spot welding method is being carried out, at least the strip end segment is automatically pressed radially outward and/or inward against the adjacent strip winding.

20. The method as claimed in claim 15, wherein a position and/or a shape of the strip end segment is automatically detected before the friction welding method is carried out.

21. The method as claimed in claim 18, wherein before the friction welding method is carried out, a space available within a coil eye of the coil for a friction welding device of the welding robot insertable therein is automatically detected.

22. The method as claimed in claim 21, wherein the friction welding device is automatically supported on the coil while the friction welding method is being carried out.

23. A device for fixing a strip end segment of a metal strip wound into a coil to a strip winding of the coil arranged adjacent to the strip end segment, having a holding device; wherein the holding device has at least one friction welding device insertable into an end of a coil eye of the coil for the materially-bonded connection of the strip end section to the strip winding and at least one support unit for automatically supporting the friction welding device inside the coil eye, wherein the friction welding device has a housing having an opening and the support unit can be brought into contact with the coil through the opening.

24. The device as claimed in claim 23, wherein the holding device is designed as a welding robot.

25. The device as claimed in claim 23, wherein the holding device has at least one sensor unit for detecting a position and/or a shape of the strip end segment and/or for detecting a space available within the eye of the coil for the friction welding device insertable therein.

26. The device as claimed in claim 23, wherein the welding robot/the holding device has at least one protective unit for externally protecting the friction welding device and/or at least one cooling unit for cooling the friction welding device.

27. The device as claimed in claim 23, wherein the holding device has at least one cooling unit for cooling the friction welding device.

28. The device as claimed in claim 23, wherein the friction welding device is a friction stir welding device or a friction spot welding device.
